(19) United States
(12) Patent Application Publication
(10) Pub. No.: US 2008/0211221 A1
(43) Pub. Date: Sep. 4, 2008

(54) Notebook system

(76) Inventors: Tina Asquith, New York, NY (US); Esther Mun, New York, NY (US)

Correspondence Address: Klaus P. Stoffel;Wolff & Samson, One Boland Drive, West Orange, NJ, 07052, US

(21) Appl. No.: 11/906,369

(22) Filed: Oct. 2, 2007

Related U.S. Application Data
(60) Provisional application No. 60/851,801, filed on Oct. 13, 2006.

(51) Int. Cl. B42D 3/00; B42D 1/00; B42F 13/00

(52) U.S. Cl. 281/31; 281/29; 281/15.1; 402/73

(57) ABSTRACT

A notebook system, including a plurality of notebooks each having a front cover and a back cover connected along one edge by a binding, and a pocket provided on an outer side of the front cover and/or the back cover of each of the notebooks. The front cover or back cover of one of the notebooks is insertable into the pocket of another of the notebooks.

This application claims the benefit of Provisional Application 60/851,801 filed Oct. 13, 2006.

### BACKGROUND OF THE INVENTION

The present invention relates to books, particularly notebooks, binders, planners, etc.

Notebooks have been in existence for a number of years and are used in both work and school settings. Although notebooks themselves have proven to be easy to use, the difficulty rises when an individual has more than one notebook and needs to transport or store these notebooks in an orderly manner. Traditionally, a student will place his/her notebooks together in either a backpack or a locker or a desk, while a worker in a similar manner will store or transport notebooks in a desk or briefcase or file drawer. The problem with this is that the notebooks do not remain together and can shift and slide making it difficult to find the desired notebook from the disheveled pile. Another drawback of existing notebooks is that they are normally sold as single subject, three subject or five subject notebooks with appropriate dividers distributed in the sheets of the notebook. It often results that someone using a single subject notebook would like to add additional subjects to the notebook but cannot do so easily since there are no dividers present. Also, if a person needed something other than a notebook, such as a calendar, it would be necessary to obtain a separate calendar or planner.

### SUMMARY OF THE INVENTION

Accordingly, it is an object of the present invention to provide a modular notebook system which allows individual components to be interconnected as desired.

Pursuant to this object, and others which will become apparent hereafter, one aspect of the present invention resides in a notebook having a back cover, a front cover and a plurality of sheets between the front cover and the back cover. The covers and the sheets being attached along one edge to form a book. Although the sheets and covers can be attached along either a vertical edge or a horizontal edge of the book, the following description will be directed to connection along a vertical edge with the understanding that the same construction and features apply if the covers and sheets are bound along a horizontal edge.

The front cover is provided with a pocket having an opening that is parallel to the binding of the notebook.

The pocket is dimensioned to receive the back cover of another notebook so that two notebooks can be combined together.

Of course the cover of the second notebook can also have a pocket which allows yet another notebook to be added.

Rather than additional notebooks, it is possible to insert planners, folders, etc.

The pocket is dimensioned to be substantially the size of the back cover of the notebook, i.e. slightly larger so as to permit easy sliding of the back cover into the pocket.

The inventive notebooks are a new system developed with the understanding that individuals have different needs, goals, and ways to organize, their lives. The modular design allows one to choose the components they need and link them to create a unique customized book. Through the linking system someone can combine a planner with a notebook, or choose to link several notebooks of different subjects together. The notebooks stays together until you want them to come a apart. Given the freedom to add and subtract notebooks and planners, as well as other supplements, the system is flexible to meet the needs of each individual.

Other features and advantages of the present invention will become apparent from the following description of the invention that refers to the accompanying drawings.

### BRIEF DESCRIPTION OF THE DRAWINGS

FIG. 1 is a front view of a notebook with the front cover pocket;

FIG. 2 shows two notebooks prior to connecting;

FIG. 3 shows one notebook being inserted into the pocket of another;

FIG. 4 shows two notebooks connected together;

FIG. 5 shows the inside of the front cover of the notebook;

FIG. 6 shows the notebook cover dielines; and

FIG. 7 shows the pocket dieline.

### DETAILED DESCRIPTION OF THE INVENTION

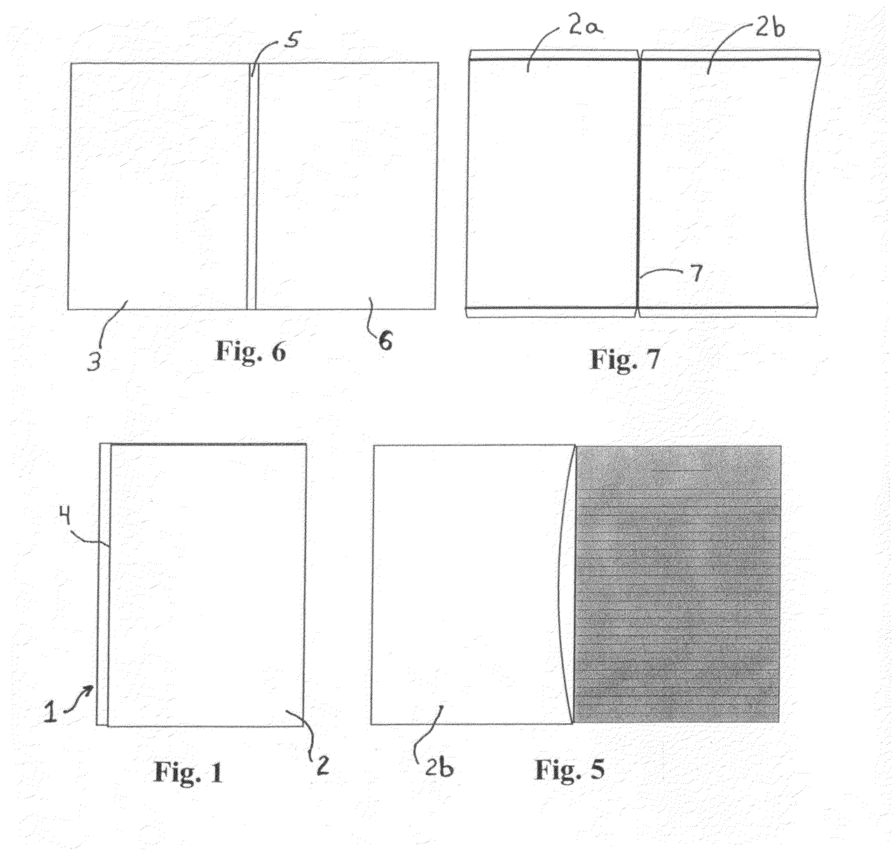

As shown in FIG. 1, the notebook 1 of the present invention has a pocket 2 mounted on the front cover 3 of the notebook. The opening of the pocket is along an edge 4 in a region of the binding or spine 5 between the front cover 3 and the back cover 6.

As visible in the drawings, the pocket 2 covers substantially the entire front cover 3 of the notebook. What is important is that the depth of the pocket 2 is sufficient to hold the back cover 6 of a further notebook. Thus, it is foreseeable that the pocket does not have to cover substantially all of the cover as shown in the drawings.

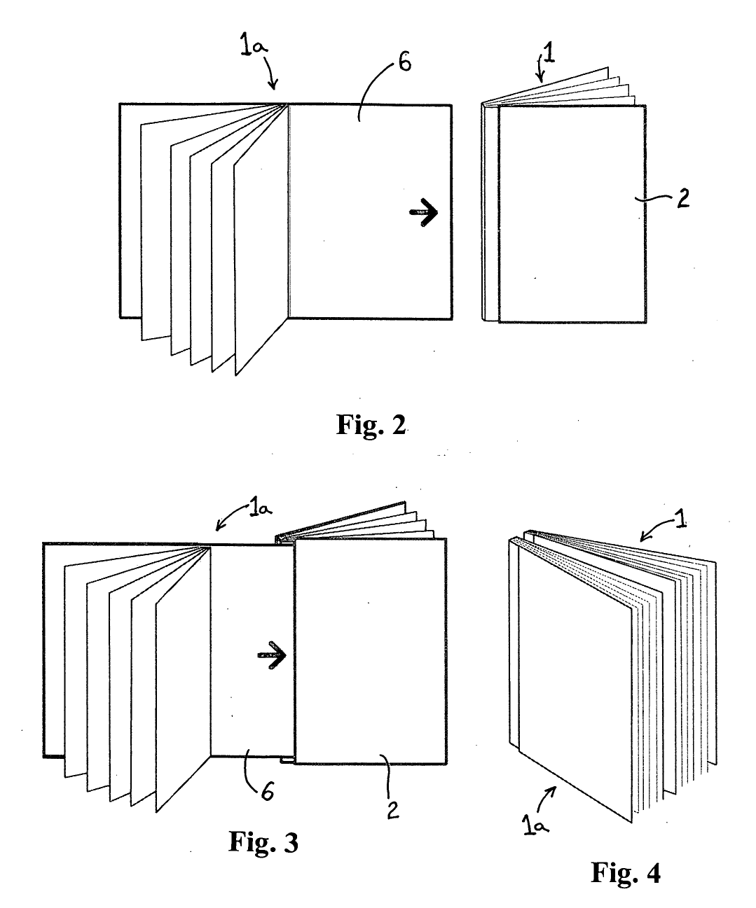

As shown in FIGS. 2-4, the back cover 6 of a second notebook 1a is slid into the pocket 2 of the notebook 1. The pocket 2 is dimensioned to be slightly larger than the cover to allow easy sliding of the back cover 6 into and out of the pocket.

One possible way of constructing the notebook is to form the front and back covers as a single piece, as shown in FIG. 6. The pages to be provided between the covers are then mounted to the spine 5 in any one of a number of known conventional ways. One embodiment of the pocket 2 is shown in FIG. 7. In this embodiment, the pocket is made up of two parts 2a and 2b which are connected together along a fold line 7. Essentially, the pocket 2 is folded over the front cover 3 and glued to the cover so that there is an external pocket as shown in FIGS. 1, 2 and 3, and an internal pocket as shown in FIG. 5.

In another embodiment only the external pocket is provided.

It is also possible to provide a pocket only on the back cover or on both the front and back cover.

As previously mentioned, the system provided by the present invention allows any desired number of notebooks to be connected together to suit an individual's needs or desires. It is also understood that even though the present invention has been described in connection with notebooks, other types of books can also be connected together, for example a notebook and a planner or a calendar. Also, the pocket can be provided on the back cover instead of the front cover or the binding of the covers can be along a horizontal edge instead of a vertical edge as previously described.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A notebook system, comprising:
a notebook having a front cover and a back cover connected along one edge by a binding; and
a pocket provided on an outer side of the front cover and/or the back cover.

2. The notebook system according to claim 1, wherein the pocket has an opening edge that extends parallel to the binding edge of the cover.

3. The notebook system according to claim 1, and further comprising a plurality of pages between the front cover and the back cover, and attached to the binding.

4. The notebook system according to claim 1, wherein the pocket is dimensioned to receive a front cover or back cover of a further notebook.

5. The notebook system according to claim 1, wherein the pocket covers substantially the entire cover.

6. The notebook system according to claim 1, and further comprising a second notebook having a front cover, a back cover, and a pocket on an outer side of the front cover and/or the back cover.

7. The notebook system according to claim 1, and further comprising a calendar insertable into the pocket.

8. The notebook system according to claim 1, and further comprising a planner insertable into the pocket.

9. The notebook system according to claim 1, wherein the front cover and the back cover are formed as a single piece.

10. The notebook system according to claim 1, wherein the pocket is made up of two parts connected together along a fold line, the two parts being folded over the cover and mounted to the cover so as to form an external pocket on the outer side of the cover and an internal pocket on an inner side of the cover.

11. A notebook system, comprising:
a plurality of notebooks each having a front cover and a back cover connected along one edge by a binding; and
a pocket provided on an outer side of the front cover and/or the back cover of each of the notebooks, wherein the front cover or back cover of one of the notebooks is insertable into the pocket of another of the notebooks.
